(19) United States
(12) Patent Application Publication
(10) Pub. No.: US 2025/0254062 A1
(43) Pub. Date: Aug. 7, 2025

(54) METHOD FOR CONNECTING A DEVICE TO A WIRELESS COMMUNICATION NETWORK

(71) Applicant: ELECTROLUX APPLIANCES AKTIEBOLAG, Stockholm (SE)

(72) Inventor: Bjarne NEBELONG, Stockholm (SE)

(73) Assignee: ELECTROLUX APPLIANCES AKTIEBOLAG, Stockholm (SE)

(21) Appl. No.: 18/855,094

(22) PCT Filed: Apr. 14, 2022
(86) PCT No.: PCT/EP2022/060051

§ 371 Date: Oct. 8, 2024

(51) Int. Cl. H04L 12/28; H04L 41/0806; H04W 48/12

(52) U.S. Cl. CPC H04L 12/282; H04L 12/2809; H04L 41/0806; H04W 48/12

(57) ABSTRACT

A method is disclosed for connecting a household device to a wireless communication network. The method may include
broadcasting, at the household device, identification information of the household device,
receiving, at a user device,
   the identification information,
   identifying, at the user device, the household device,
      prompting, at the user device, the user to perform a confirmation action to confirm an attendance of the user in proximity of the household device,
detecting, at the household device, the confirmation action and notifying it to the user device,
transmitting, at the user device, to the household device, network configuration data for connection to the wireless communication network, and
configuring, at the household device, a connection of the household device to the wireless communication network according to the network configuration data.

### TECHNICAL FIELD

The present disclosure generally relates to a method (and a corresponding system) for configuring a connection to a wireless communication network. Particularly, the present invention relates to a method (and a corresponding system) for connecting a household appliance to a wireless communication network.

### Background Art

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

In recent years, there has been rapid advancement in connected or smart environments. A typical connected or smart environment is implemented by a wireless communication network (hereinafter, Wi-Fi network), such as a wireless local area network (WLAN), and allows client devices connected to (or accessing) the Wi-Fi network to connect to each other and/or to external communication network (such as the Internet network).

A Wi-Fi network (and the connectivity to it) is typically implemented by a wireless access point apparatus (hereinafter concisely referred to as Wi-Fi apparatus), or more thereof, such as Wi-Fi modem, a Wi-Fi router and/or a Wi-Fi gateway. In order to connect to the Wi-Fi apparatus (and, hence, to the respective Wi-Fi network), a client device has to be configured or set up with corresponding network configuration data. For a conventional Wi-Fi apparatus, the network configuration data may comprise a respective “Service Set Identifier” (hereinafter, SSID identifier) and a respective authentication key (for example, password), whereby a client device may establish a communication session with the Wi-Fi apparatus (and, hence, connect to the Wi-Fi network) by selecting the corresponding SSID identifier and entering the corresponding password.

An increasing number of household appliances now offer networking capability supporting connectivity to a Wi-Fi network (hereinafter, Wi-Fi connectivity).

### SUMMARY

The Applicant has realized that the household appliances supporting Wi-Fi connectivity currently on the market, and especially the network provisioning procedures required for connecting them to the Wi-Fi networks, are not satisfactory.

According to the Applicant, this dissatisfaction is due to the fact that many household appliances have no or minimal user interfaces. Typically, this could the case for small appliances (such as microwave ovens, toasters, humidifiers, food processors and coffeemakers) and for a relevant number of large appliances (such as freezers, refrigerators, water coolers, ice makers, kitchen stoves, cooking hobs, ovens and air conditioners). For household appliances having no or minimal user interfaces, the network provisioning procedures involve convoluted operations, which may be discouraging for the users.

According to the Applicant, this dissatisfaction is due also to the fact that the more evolved user interfaces a few household appliances are equipped with (such as some large appliances including washing machines, drying machines, combined washing/drying machines, and dishwashers), are unpractical and unsuitable for complex or relatively complex forms of interactions, such as the input of a password to access a Wi-Fi network, especially when the password is, for security reasons, a long or relatively long string of characters including letters, numbers, and symbols. This strongly affects user experience.

The Applicant is aware of the presence of network provisioning procedures based on communication between the household appliance and a user device (such as a smartphone). However, the Applicant believes that these procedures are generally unsecure, in that they do not provide mechanisms for preventing non-allowed uses by non-authorized persons (for example by user's neighbors that (voluntarily or unintentionally) establish a connection with the household appliance of the user), and they do not provide mechanisms for preventing some categories of persons (such as children) to cause trouble by reckless or unaware use of advanced features (such as Wi-Fi connectivity) of the household appliance.

In view of the above, the Applicant has devised a method, and a corresponding system for connecting a household appliance to a Wi-Fi network.

An aspect of the present disclosure relates to a method for connecting a device, for example a household device, to a wireless communication network.

According to an embodiment, the method may comprise, at the household device, broadcasting, using short-range wireless communication technology, identification information of the household device.

According to an embodiment, the method may comprise, at a user device (for example, a personal user device) associated with a user of the household device, receiving the identification information of the household device using the short-range wireless communication technology.

According to an embodiment, the method may comprise, at the user device, identifying the household device based on the received identification information.

According to an embodiment, the method may comprise, at the user device, prompting the user to perform a confirmation action, associated with the identified household device, to confirm an attendance of the user in proximity of the household device.

According to an embodiment, the method may comprise, at the household device, detecting the confirmation action and notifying it to the user device using the short-range wireless communication technology.

According to an embodiment, the method may comprise, at the user device, in response to being notified of the detected confirmation action, transmitting to the household device, using the short-range wireless communication technology, network configuration data for connection to the wireless communication network.

According to an embodiment, the method may comprise, at the household device, configuring a connection of the household device to the wireless communication network according to the network configuration data.

According to an embodiment, the confirmation action, associated with the household device, may comprise a direct interaction between the user and the household device.

According to an embodiment, the confirmation action may comprise an action to be performed on an actuatable mechanical part of the household device.

According to an embodiment, the confirmation action, associated with the household device, may comprise moving a door of the household device.

According to an embodiment, the confirmation action, associated with the household device, may comprise pressing and/or releasing a home or a mode button on the household device.

According to an embodiment, the confirmation action, associated with the household device, may be based on the identification information.

According to an embodiment, the identification information may comprise at least one between a type of household device and a model of the household device.

According to an embodiment, said detecting the confirmation action may further comprise, at the household device, detecting that the confirmation action is performed within a prescribed time limit.

According to an embodiment, the method may further comprise, if no confirmation action is detected to be performed within the prescribed time limit, repeating said prompting the user to perform the confirmation action, and said detecting the confirmation action.

According to an embodiment, said prompting the user to perform the confirmation action may further comprise, at the user device, transmitting a corresponding notification to the household device.

According to an embodiment, the prescribed time limit may be counted by the household device starting from reception of the notification at the household device.

According to an embodiment, the method may further comprise, following reception at the user device of the identification information, transmitting, at the user device, a response to the household device to allow pairing of the household device and the user device to each other.

According to an embodiment, the method may further comprise, at the household device, providing to the user device a set of available wireless communication networks, and, at the user device, selecting a wireless communication network among the set of available communication networks.

According to an embodiment, said prompting the user to perform the confirmation action may be performed in response to said selecting a wireless communication network.

According to an embodiment, said selecting a wireless communication network may comprise, if a known wireless communication network exists among the available wireless communication networks, and if the user wishes to connect the household device to the known wireless communication network, automatically retrieving the network configuration data associated with the known wireless communication network.

According to an embodiment, the method may further comprise, at the household device, performing short-range wireless communication activation at a power on of the household device.

According to an embodiment, the method may further comprise, at the household device, performing short-range wireless communication deactivation after a predefined time.

According to an embodiment, the short-range radio communication technology may be based on at least one among Bluetooth, NFC, RFID, ZigBee, and UWB technologies.

According to an embodiment, the user device may comprise a mobile device, such as a smartphone, a tablet or a wearable device.

Another aspect of the present disclosure relates to a method implemented by a household device for connecting the household device to a wireless communication network.

According to an embodiment, the method may comprise broadcasting, using a short-range wireless communication technology, identification information of household device to allow the household device to be identified by a user device.

According to an embodiment, the user device may be associated with a user of the household device.

According to an embodiment, the method may comprise detecting a confirmation action, associated with the household device, performed by the user to confirm an attendance of the user in proximity of the household device.

According to an embodiment, the method may comprise notifying, using the short-range wireless communication technology, the detection of the confirmation action to the user device.

According to an embodiment, the method may comprise receiving from the user device, using the short-range wireless communication technology, network configuration data for the wireless communication network.

According to an embodiment, the method may comprise configuring a connection of the household device to the wireless communication network according to the network configuration data.

Another aspect of the present disclosure relates to a method implemented by a user device for connecting a household device to a wireless communication network.

According to an embodiment, the method may comprise receiving identification information of the household device broadcasted by the household device using a short-range wireless communication technology.

According to an embodiment, the method may comprise identifying the household device according to the identification information.

According to an embodiment, the method may comprise prompting the user to perform a confirmation action, associated with the identified household device, to confirm an attendance of the user in proximity of the household device.

According to an embodiment, the method may comprise receiving, using the short-range wireless communication technology, a notification of the detection of the confirmation action from the household device.

According to an embodiment, the method may comprise transmitting, using the short-range wireless communication technology, network configuration data for connecting the household device to the wireless communication network.

Another aspect of the present disclosure relates to a computer program product directly loadable into an internal memory storage of a processing unit within a household device, the computer program product comprising software code means for performing the steps of the method of above when the computer program product is run on the household device.

Another aspect of the present disclosure relates to a computer program product directly loadable into an internal memory storage of a processing unit within a user device, the computer program product comprising software code means for performing the steps of the method of above, when the computer program product is run on the user device.

A further aspect of the present disclosure comprises a household device.

According to an embodiment, the household device may comprise a control unit for controlling an operation of the household device.

According to an embodiment, the household device may comprise a short-range wireless communication module for allowing the household device to communicate with a user device, associated with a user of the household device, using a short-range wireless communication technology.

According to an embodiment, the household device may comprise a wireless communication module for allowing the household device to connect to a wireless communication network.

According to an embodiment, the control unit may be configured to broadcast, through the short-range wireless communication module, identification information of household device to allow the household device to be identified by the user device.

According to an embodiment, the control unit may be configured to detect a confirmation action, associated with the household device, performed by the user to confirm an attendance of the user in proximity of the household device.

According to an embodiment, the control unit may be configured to notify, through the short-range wireless communication module, the detection of the confirmation action to the user device.

According to an embodiment, the control unit may be configured to receive from the user device, through the short-range wireless communication module, network configuration data associated with the wireless communication network.

According to an embodiment, the control unit may be configured to configure the wireless communication module with the network configuration data.

Another aspect of the present disclosure relates to a method for connecting a first device to a wireless communication network.

According to an embodiment, the method may comprise, at a second device, causing a prompt to be displayed, for example on a user interface of the second device, to a user of the second device to perform a confirmation action, associated with the first device, to confirm an attendance of the user in proximity of the first device.

According to an embodiment, the method may comprise, at the first device, communicating information indicative of the confirmation action having been performed, to the second device using a wireless communication protocol.

According to an embodiment, the method may comprise, at the second device, in response to receiving the information indicative of the confirmation action having been performed, transmitting to the first device, using the wireless communication protocol, network configuration data for connection to the wireless communication network.

According to an embodiment, the method may comprise, at the first device, configuring a connection of the first device to the wireless communication network according to the network configuration data.

According to an embodiment, the confirmation action may comprise turning on a wireless communication unit in the first device corresponding to the wireless communication protocol, and communicating information indicative of the confirmation action having performed may comprise the wireless communication unit broadcasting identification information.

Further aspects of the present disclosure relate to a corresponding system, corresponding first and second devices and corresponding computer program products.

### BRIEF DESCRIPTION OF THE ANNEXED DRAWINGS

These and other features and advantages of the present disclosure will be made apparent by the following description of some exemplary and non-limitative embodiments thereof; for its better intelligibility, the following description should be read referring to the attached drawings, wherein:

FIG. 1 shows a system according to embodiments of the present disclosure;

FIG. 2 shows an activity diagram of a method implementing a network provisioning procedure, according to embodiments of the present disclosure, and

FIGS. 3A-3E show exemplary screens displayed on a user device during the network provisioning procedure, according to embodiments of the present disclosure.

### DETAILED DESCRIPTION

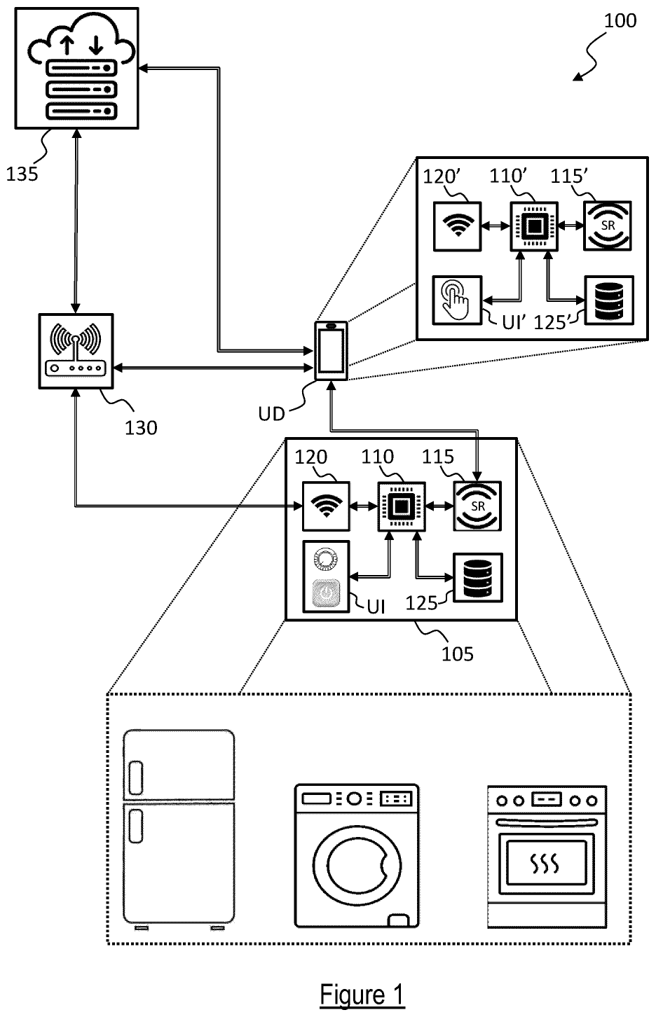

With reference to the drawings, FIG. 1 shows a system 100 according to an embodiment of the present disclosure.

In the following, when one or more features of the system (as well as of parts thereof and/or method steps implemented thereby) are introduced by the wording “according to an embodiment”, they are to be construed as features additional or alternative to any features previously introduced, unless otherwise indicated and/or unless there is evident incompatibility among feature combinations.

In the following, the terms “include” and “comprise”, and derivatives thereof, are intended to specify the presence of stated features, integers, steps, operations, elements, and/or components, but do not preclude the presence or addition of one or more other features, integers, steps, operations, elements, components, and/or groups thereof.

According to an embodiment, the system 100 comprises a household appliance 105.

Without losing generality, the household appliance 105 may comprise any household appliance for home or professional use. Examples of household appliance that may implement and take advantage of the present disclosure include, but are not limited to, small appliances (such as microwave ovens, toasters, humidifiers, food processors and coffeemakers) and large appliances (such as freezers, refrigerators, water coolers, ice makers, kitchen stoves, cooking hobs, ovens, washing machines, drying machines, combined washing/drying machines, dishwashers, and air conditioners).

A refrigerator, a washing machine and an oven are schematically represented in FIG. 1 as examples of household appliance 105, although this should not be construed limitatively.

In the following, only components of the household appliance 105 deemed relevant for the understanding of the present disclosure will be discussed for the sake of conciseness.

According to an embodiment, the household appliance 105 comprises a control unit 110 configured to control an operation of the household appliance 105. According to an embodiment, the control unit 115 is configured to control the operation of the household appliance 105 based on a plurality of functionalities of the household appliance 105.

According to an embodiment, the control unit 110 is configured to control the operation of the household appliance 105 according to instructions received by the user through a user interface UI of the household appliance 105. Without losing generality, the user interface UI may for example comprise a physical user interface (which may be physically provided on the household appliance).

For the purposes of the present disclosure, the physical user interface may comprise one or more components among a button (or more thereof), a key (or more thereof), a rotary knob (or more thereof), a screen (or more thereof), a door (or more thereof) and a drawer (or more thereof) associated with (or for selecting) corresponding functionalities of the household appliance.

According to an embodiment, the user interface UI of the household appliance 105 may further comprise a virtual user interface (not shown). For the purposes of the present disclosure, the virtual user interface may allow selecting one or more functionalities of the household appliance by a software application running (or designed to run) on a user device (such as a mobile application designed to run on a mobile device such as a smartphone, a tablet, or a smartwatch) or a desktop application running (or designed to run) on desktop and laptop computers.

According to an embodiment, the household appliance 105 comprises a short-range radio signal module (hereinafter concisely referred to as SR module) 115 configured to exchange (i.e., transmit and receive) data over one or more short-range radio communication channels (hereinafter concisely referred to as SR communication channel) with electronic devices having communication capabilities through the SR communication channel. In other words, the household appliance 105 implements (by means of the SR module 115) a short-range wireless communication functionality (hereinafter, SR functionality) of the household appliance 105 allowing communication of the household appliance 105 over the SR communication channel.

According to an embodiment, the SR functionality may be based on Bluetooth™ technology (and on a respective communication protocol). For example, the SR functionality may be based on Bluetooth™ Low Energy (BLE) technology (and on a respective communication protocol). According to an embodiment, the SR functionality may be based, additionally or alternatively to Bluetooth™ technology, on one or more among ultra-wideband (UWB), NFC, RFID, and ZigBee technologies (and on respective communication protocols).

According to an embodiment, the control unit 110 and the SR module 115 are communicably coupled to each other (e.g., through a corresponding communication bus).

According to an embodiment, the household appliance 105 comprises a wireless (or Wi-Fi) communication module (hereinafter concisely referred to as Wi-Fi module) 120 for allowing connection of the household appliance 105 to a wireless communication network (hereinafter concisely referred to as Wi-Fi network). An example of Wi-Fi network includes, but is not limited to, a wireless local area network (WLAN).

For the purposes of the present disclosure, the Wi-Fi network implements a connected or smart environment, separate (i.e., distinct and independent) from the SR communication channel, allowing client devices connected to the Wi-Fi network to connect to each other (e.g., so as to become part of the smart environment) and/or to an external communication network (such as the Internet network). Without losing generality, the smart environment may refer to a smart environment for any living space (such as homes, duplexes, townhomes, multi-unit apartment buildings, hotels) or work space (such as retail stores, office buildings, industrial buildings).

According to an embodiment, the control unit 110 and the Wi-Fi module 120 are communicably coupled to each other (e.g., through a corresponding communication bus).

According to an embodiment, the household appliance 105 comprises a memory module 125.

According to an embodiment, the memory module 125 comprises a non-volatile memory (e.g., a ROM memory) for storing basic code for a bootstrap of the household appliance 105.

According to an embodiment, the memory module 125 comprises a volatile memory (e.g., a RAM memory) used as a working memory by the control unit 110.

According to an embodiment, the memory module 125 comprises a mass-memory for storing programs and data.

According to an embodiment, the control unit 110 and the memory module 125 are communicably coupled to each other (e.g., through a corresponding communication bus).

According to an embodiment, the system 100 comprises a user device UD. According to an embodiment, the user device UD is a personal device (e.g., a personal communication device) associated with a user of the household appliance 105. The user may for example be an owner of the household appliance 105 and of the user device UD.

According to an embodiment, the user device UD may comprise a mobile device (e.g., a smartphone, as exemplarily illustrated, a personal digital assistant (PDA), a tablet, or a wearable device, such as a smartwatch), or any electronic device having similar processing and connection capabilities (e.g., a personal computer or a laptop computer).

For the purposes of the present disclosure, the user device UD is an electronic device capable of exchanging data with the household appliance 105 (e.g., with the SR module 120 thereof) over the SR communication channel, to allow a nearby or proximity interaction between the user device UD and the household appliance 105 (e.g., in order to implement a network provisioning procedure aimed at connecting the household appliance 105 to the Wi-Fi network, as better discussed in the following).

According to an embodiment, the user device UD comprises a control unit 110′ configured to control an operation of the user device UD.

According to an embodiment, the control unit 110′ is configured to control the operation of the user device UD according to instructions received by the user through a user interface UI′ of the user device UD. Without losing generality, the user interface UI′ may for example comprise a touch-sensitive display of the user device UD.

According to an embodiment, the user device UD comprises a SR module 115′ configured to exchange data over one or more SR communication channels. For the purposes of the present disclosure, the SR module 115′ of the user device UD allows exchange of data with the household appliance 105 (i.e., with or through the respective SR module 115). For the purposes of the present disclosure, features, alternatives and combinations thereof discussed above in connection with the SR module 115 of the household appliance 105 may be equivalently applied to the SR module 115′ of the user device UD.

According to an embodiment, the user device UD comprises a Wi-Fi module 120′ for allowing connection of the user device UD to a Wi-Fi network. For the purposes of the present disclosure, features, alternatives and combinations thereof discussed above in connection with the Wi-Fi module 120 of the household appliance 105 may be equivalently applied to the Wi-Fi module 120′ of the user device UD.

According to an embodiment, the user device UD comprises a memory module 125′. Similarly to the memory module 125 of the household appliance 105, the memory module 125′ of the user device UD may include, but is not limited to, one or more among a ROM memory (e.g., for storing basic code for a bootstrap of the user device UD), a RAM memory (e.g., used as a working memory by the control unit 110), and a mass-memory (e.g., for storing programs and data).

According to an embodiment, the system 100 comprises a wireless access point apparatus (hereinafter concisely referred to as Wi-Fi apparatus) 130 for providing connectivity to the Wi-Fi network (and, hence, to the connected or smart environment). Without losing generality, the Wi-Fi apparatus 130 may comprise a Wi-Fi modem, a Wi-Fi router and/or a Wi-Fi gateway.

According to an embodiment, the Wi-Fi apparatus 130 is associated with a respective “Service Set Identifier” (hereinafter, SSID identifier) and a respective password (or other authentication key), whereby a client device may establish a communication session with the Wi-Fi apparatus 130 (and, hence, connect to the Wi-Fi network) by selecting the corresponding SSID identifier and entering a corresponding password. Without losing generality, the password (or other authentication key) may be a string of characters including, but not limited to, letters, numbers, and symbols. Without losing generality, the SSID identifier associated with the Wi-Fi apparatus 130 and the corresponding password identify respective network configuration data, whereby a client device configured with the network configuration data is allowed to connect to the Wi-Fi apparatus 130 (and, hence, to the Wi-Fi network).

According to an embodiment, the system 100 comprises a computing structure, such as a server, 135.

For the purposes of the present disclosure, the server 135 is a server associated with (e.g., held by) a manufacturer of the household appliance 105 (hereinafter, appliance manufacturer). The server 135 may comprise one or more servers providing, as a whole, a cloud such as a home appliance control cloud.

According to an embodiment, the Wi-Fi apparatus 130 and the server 135 are communicably coupled to each other through respective one or more wireless communication links (such as Wi-Fi and/or cellular communication links) and/or wired communication links (such as optical fiber communication links), so as to provide a communicable coupling between the server 135 and any client device (such as the household appliance 105) connected to the Wi-Fi apparatus 130.

Without losing generality, as conceptually represented in the figure, the server 135 and the user device UD may be communicably coupled to each other through the Wi-Fi apparatus 130 (in which case the user device UD may connect to the Wi-Fi apparatus 130 through a respective Wi-Fi module, not shown), or without (or without intermediation of) the Wi-Fi apparatus 130 (in which case the user device UD may connect to the server 135 through one or more respective cellular modules, not shown, implementing one or more cellular communication links).

According to an embodiment, the household appliance 105 and the user device UD may connect to the server 135 via the Internet.

Just as an example, connection between the household appliance 105 and the server 135 may allow the appliance manufacturer to deliver one or more services for (or associated with) the household appliance 105 (such as software/firmware update, and/or information to the user). As a specific example, connection between the household appliance 105 and the server 135 may allow the household appliance 105 to be remotely controlled.

Just as another example, connection between the household appliance 105 and the user device UD may allow the user device UD to interface with the household appliance 105, for example during the network provisioning procedure (as discussed in more detail in the following).

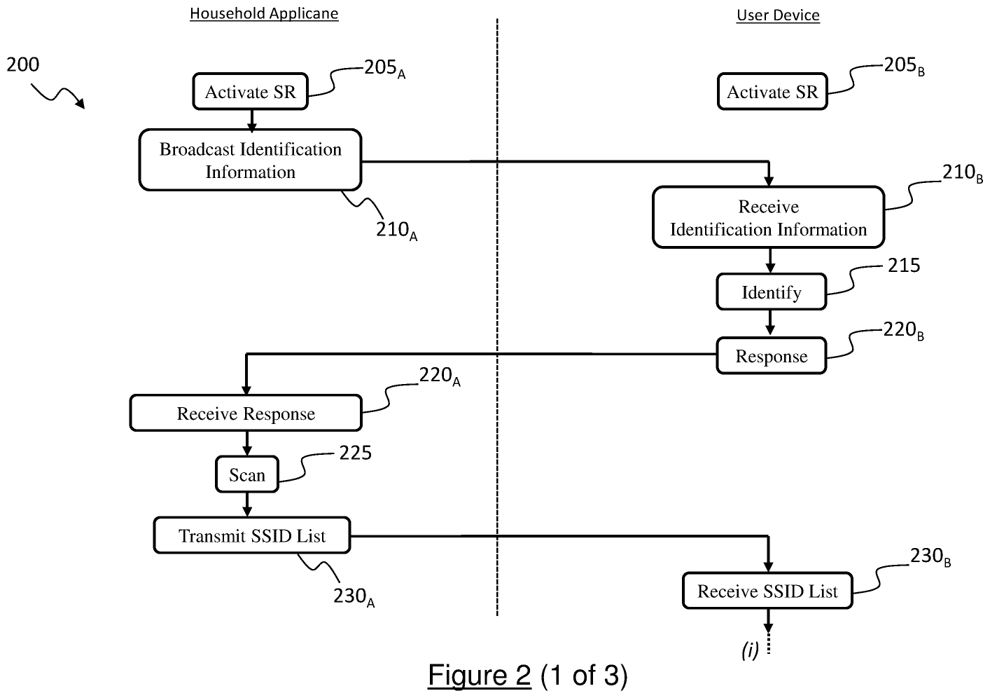

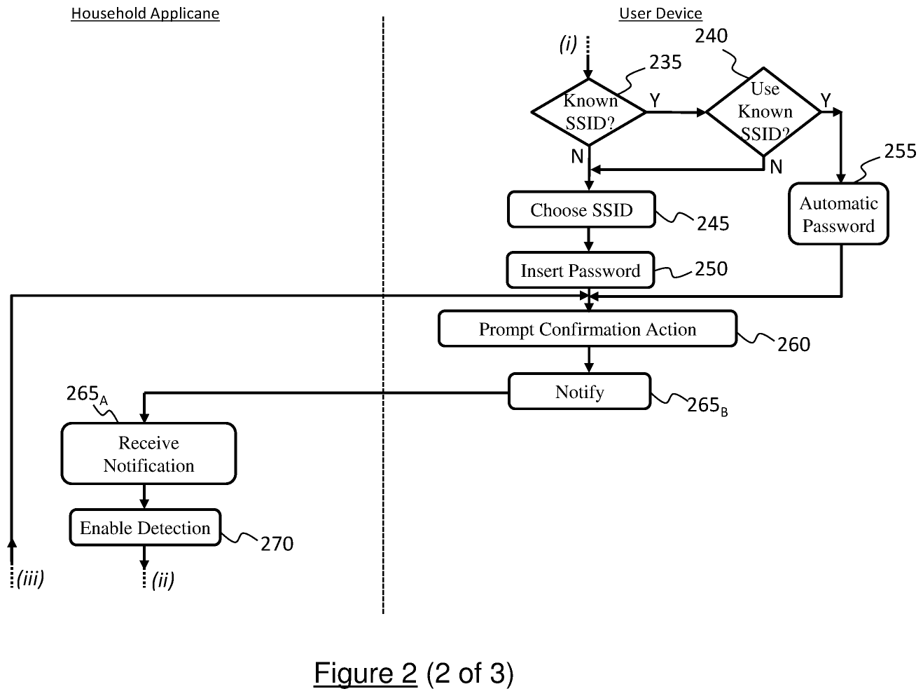

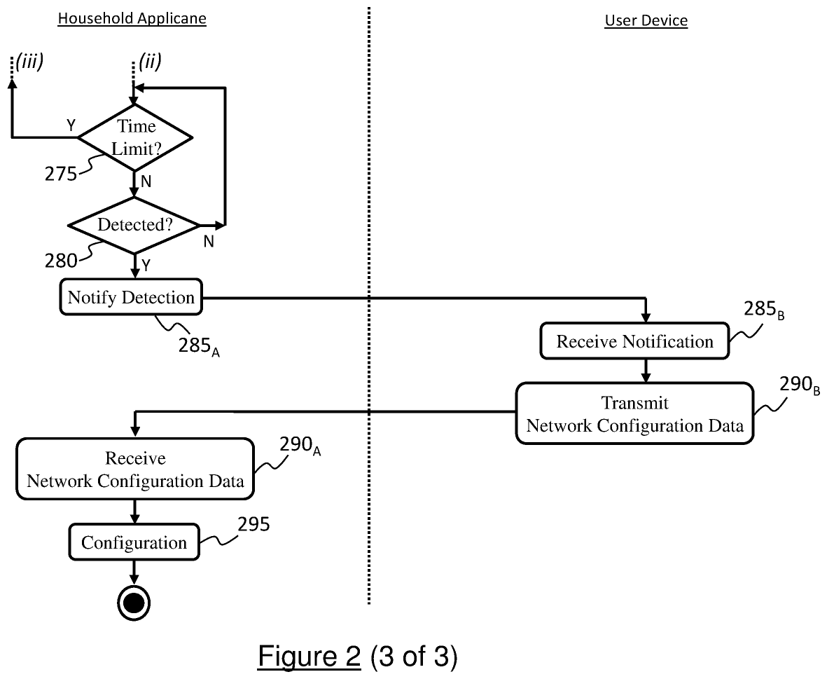

With reference now to FIG. 2, it shows an activity diagram of a method 200 implementing a network provisioning procedure, according to embodiments of the present disclosure. Particularly, FIG. 2 shows a swim-lane activity diagram which describes the flow of activities relating to an exemplary embodiments of the present disclosure. In this respect, each node of the activity diagram may correspond to one or more executable instructions for implementing the specified logical function on a relevant software component of a respective actor (i.e., the household appliance 105 or the user device UD).

According to an embodiment, the method steps performed by the household appliance 105 and by the user device UD may be implemented by respective computer program products loadable into a digital memory of the household appliance 105 and of the user device UD. According to an embodiment, each computer program product comprises software code means for performing the method steps when the computer program product is run (on the household appliance 105 or on the user device UD).

By computer program product loadable into a digital memory of an apparatus (such as the household appliance 105 and/or the user device UD), it is herein meant that the computer program can be introduced into the digital memory of the relevant apparatus so as achieve an apparatus programmed to be capable of, or adapted to, carrying out the corresponding method steps.

Without losing generality, the computer program product implementing the method steps performed by the household appliance 105 may comprise, or be included in, a firmware of the household appliance 105, the firmware being for example stored in a memory location of the control unit 110.

Without losing generality, the computer program product implementing the method steps performed by the user device UD may comprise, or be included in, a software application downloaded and installed on the user device UD. In the exemplary considered case in which the user device UD comprises a mobile device, the software application may comprises a mobile application (hereinafter, mobile app) downloaded from a digital distribution platform associated with the operating system of the mobile device (or from the server 135), and installed on the user device UD. Without losing generality, installation of the mobile app (or, more generally, of the software application) on the mobile device (or, more generally, on the user device UD) also provides for a log-in by the user with a corresponding registered account (so as to provide an initial user authentication).

As mentioned above, the method 200 is aimed at connecting the household appliance 105 to a Wi-Fi network by means of data exchanged between the household appliance 105 and the user device UD over the SR communication channel. Without losing generality, the data exchanged between the household appliance 105 and the user device UD over the SR communication channel may comprises values (including, but not limited to, SSID identifiers, passwords and identification information) and notifications (such as signaling relating to events).

Broadly speaking, the method 200 comprises, following reception, at the user device UD, of identification information identifying the household appliance 105, prompting the user to perform a confirmation action to confirm an attendance or presence of the user in proximity of the household appliance 105, and, in response to detection, by the household appliance 105, of the confirmation action, causing or triggering the user device UD to transmit (to the household appliance 105) network configuration data relating to a Wi-Fi network (for example the Wi-Fi network implemented by the Wi-Fi apparatus 130) for allowing the household appliance 105 (properly configured with the network configuration data) to connect with the Wi-Fi network (i.e., with the Wi-Fi apparatus 130).

Transmission of the network configuration data from the user device UD to the household appliance 105 allows the network configuration data to be easily fed to household appliances without user interfaces or with user interfaces (as most of the household appliances equipped with user interfaces) which are unpractical and unsuitable for complex or relatively complex forms of interactions (such as the input of long or relatively long strings characters including letters, numbers, and symbols).

The confirmation action allows ascertaining an actual attendance or presence of the user in proximity of the household appliance before transmission of the network configuration data thereto. This provides a simple and secure authentication of the user, in that it prevents non-allowed uses to non-authorized persons, for example to user's neighbors that (voluntarily or unintentionally) establish SR communication channels (e.g., through their own devices) with the household appliance 105 of the user.

Moreover, as better discussed in the following, by providing a proper level of complexity of the confirmation action, it may be possible to discourage or prevent some categories of persons from engaging in the connection of the household appliance 105 to the Wi-Fi network.

In the following discussion of the activity diagram, the term “upon” is intended to broadly mean “in response to”, without any strict temporal significance linked to the event to which the term refers.

As mentioned above, the method 200 is aimed at connecting the household appliance 105 to a Wi-Fi network by means of data exchanged between the household appliance 105 and the user device UD over the SR communication channel. In the following, any data exchange between the household appliance 105 and the user device UD is intended to take place over the SR communication channel (e.g., through the SR module 115 of the household appliance 105), although this will not always be repeated for the sake of description conciseness.

According to an embodiment, the method 200 comprises activating the SR functionality at the household appliance 105 (action node 205_{A}). According to an embodiment, the SR functionality may be automatically activated at a power on of the household appliance 105, for example, at a booting (or rebooting) of the household appliance 105 as a result of connection (or reconnection) of the household appliance 105 to a power mains. According to an embodiment, the SR functionality may be manually activated (e.g., by the user), for example by selecting a corresponding button or key, or a corresponding item of a menu or submenu of a user interface (if provided) of the household appliance 105.

SR functionality activation at the household appliance 105 may be omitted in basic embodiments. In these embodiments, the SR functionality may be activated by default, and may not be deactivated unless the user purposely selects a corresponding item of a menu or submenu of the user interface of the household appliance 105.

According to an embodiment, the SR functionality at the household appliance 105 may be automatically deactivated after a predefined time (hereinafter, SR activation time). Just as a practical example, the SR activation time may be of the order of one or more hours or of the fraction of hour. As should be understood, SR functionality deactivation determines an interruption of data exchange between the household appliance 105 and the user device UD over the SR communication channel, and hence an end of the method 200. In this embodiment, SR functionality deactivation may be notified to the user, for example through a corresponding message on the user interface of the household appliance 105 and/or of the user device UD.

According to an embodiment, the method 200 comprises activating the SR functionality at the user device UD (action node 205_{B}). According to an embodiment, the SR functionality may be automatically activated at a switch on of the user device 105. According to an embodiment, the SR functionality may be manually activated (e.g., by the user), for example by selecting a corresponding item of a menu or submenu of a user interface of the user device UD. According to an embodiment, the SR functionality may be manually activated (e.g., by the user) by selecting a corresponding item of a menu or submenu of the software application running on the user device UD.

SR functionality activation at the user device UD may be omitted in basic embodiments. In these embodiments, the SR functionality may be activated by default (for example, it may be automatically activated at the opening of the software application), and may not be deactivated unless the user purposely selects a corresponding item of a menu or submenu of the user interface of the user device UD (or of the software application running on it).

According to an embodiment, SR functionality activation at the household appliance 105 (action node 205_{A}) is performed independently from SR functionality activation at the user device UD (action node 205_{B}).

According to an embodiment, by activating the SR functionality, the household appliance 105 may become discoverable by other devices (such as the user device UD).

According to an embodiment, the method 200 comprises, at the household appliance 105, broadcasting identification information over the SR communication channel (action node 210_{A}). According to an embodiment, the identification information comprises one or more information among type, model name, model number, and serial number of the household appliance 105. According to an embodiment, the identification information is stored in a proper memory location of the control unit 110 of the household appliance 105. When communication over the SR communication channel is based on the BLE communication protocol, the identification information may be sent as part of a pairing request. For simplicity, pairing of the user device UD and the household appliance 105 is referred to in the description herein, but it should be understood that in systems using alternative communication protocols, which do not implement pairing, the household appliance 105 and the user device UD may simply establish a trusted communication link.

According to an embodiment, the method 200 comprises, at the user device UD, receiving the identification information over the SR communication channel (action node 210_{B}). According to an embodiment, reception of the identification information takes place after running or opening the software program on the user device UD. According to an embodiment, reception of the identification information triggers the running or opening of the software application on the user device UD. Without losing generality, reception of the identification information may trigger a notification on the user device UD. The notification may for example be a push notification, such as a banner on the top of the device screen and/or dialog box that interrupts and blocks the view of any running application, and may contain text and/or vocal and/or image message (possibly with the further playing of an alert sound to attract the attention of the user). According to an embodiment, selection of the notification by the user may decree the running or opening of the software application and/or the start of a provisioning process. According to an embodiment, the user may confirm or deny the opening of the software application and/or the start of the provisioning process. Just as an example, the opening of the software application and/or the start of the provisioning process may be achieved by touching on the notification or by means of other gesture (for example, by means of a sliding on the notification box).

According to an embodiment, the method 200 comprises, at the user device UD, identifying the household appliance 105 based on the received identification information (action node 215).

According to an embodiment, the identification of the household appliance 105 identifies and/or is part of a pairing process aimed at mutual recognition and/or authorization between the household appliance 105 and the user device UD for subsequent data exchange over the SR communication channel. According to an embodiment, not shown, the identification of the household appliance 105 based on the received identification information (and/or the respective pairing) may be supported or assisted (at least partially) by the server 135 (for example, by communication between the server 135 and the user device UD). The identification of the household appliance 105 may comprise the identification of the type of the household appliance 105, such that the user device UD may be allowed to filter out broadcast messages, including pairing requests, from devices (such as headphones and similar devices) that the user device UD is not interested in communicating with.

According to an embodiment, the method 200 comprises, at the user device UD, responding to the household appliance 105 (action node 220_{B}). The user device UD may respond to trigger pairing of the household appliance 105 and the user device UD. The user device UD may respond with identification information of the user device UD to establish trusted communication links or initiate the process to establish trusted communication links. For example, the household appliance 105 and the user device UD may exchange further messages (for example related to encryption) to establish secure communication. When the SR communication channel is a BLE communication channel or relies on another communication protocol that involves pairing, the response may be a pairing response.

According to an embodiment, the method 200 comprises, at the household appliance 105, upon reception of the response from the user device UD (action node 220_{A}) (or, more generally, in response to user device/household appliance pairing), activating the Wi-Fi module 120 (if not yet activated) and scanning (through the Wi-Fi module 120) for available Wi-Fi networks (action node 225). Without losing generality, the available Wi-Fi networks may comprise Wi-Fi networks having signal strengths higher than a predefined signal strength (the predefined signal strength depending, for example, on Wi-Fi module performance, such as sensitivity of a respective receiver). Without losing generality, said scanning may be automatically performed by the Wi-Fi module 120 upon its activation. For example, if the Wi-Fi module 120 is activated by default at the power on of the household appliance 105, the scanning may take place concurrently with execution of any of the action nodes 205_{A}-220_{A}.

According to an embodiment, the method 200 comprises, at the household appliance 105, e.g., upon household appliance identification and/or upon user device/household appliance pairing, transmitting, to the user device UD, through the SR communication channel, the available Wi-Fi networks (or a subset thereof) resulting from said scanning (action node 230A). The transmission may be on request from the user device UD. Alternatively, the household appliance 105 may be preconfigured to transmit the available Wi-Fi networks upon pairing and/or upon establishing a trusted communication link or connection with the user device UD. According to an embodiment, said transmitting the available Wi-Fi networks comprises transmitting a list of SSID identifiers associated with the available Wi-Fi networks (hereinafter concisely referred to as SSID list). According to an embodiment, the subset of the available Wi-Fi networks may comprise (only) private Wi-Fi networks (i.e., password protected Wi-Fi networks). According to an embodiment, the subset of the available Wi-Fi networks may exclude or not comprise public Wi-Fi networks (i.e., freely accessible and unprotected Wi-Fi networks), for example to avoid security and privacy issues.

According to an embodiment, the method 200 comprises, at the user device UD, upon reception of the SSID list (action node 230_{B}), allowing the user to perform Wi-Fi network selection (see nodes 235-255, discussed here below).

According to an embodiment, Wi-Fi network selection may be based on the presence or absence of a known Wi-Fi network among the available Wi-Fi networks, and to the willingness of the user to use the known Wi-Fi network (if present). By known Wi-Fi network it is herein meant a Wi-Fi network to which the user device UD already has access rights, and/or a Wi-Fi network already identified in the software application (in that, for example, it was used for connecting another household appliance at an earlier time).

Without losing generality, Wi-Fi network selection may be supported or guided or assisted by corresponding on-screen instructions, as progressively discussed here below.

According to an embodiment, the method 200 comprises, at the user device UD, if no known Wi-Fi network exists among the available Wi-Fi networks (exit branch N of the decision node 235), allowing the user to select a Wi-Fi network among the available Wi-Fi networks. According to an embodiment, Wi-Fi network selection may be performed by allowing the user to select or chose the corresponding SSID identifier (action node 245) and input or enter the associated password (action node 250).

Just as an example of on-screen instructions supporting or guiding or assisting the Wi-Fi network selection in this use-case, the user device UD may display the received SSID list on the corresponding screen and, upon SSID selection, open a fillable box for entering the password.

According to an embodiment, the method 200 comprises, at the user device UD, if a known Wi-Fi network exists among the available Wi-Fi networks (exit branch Y of the decision node 235), but the user does not wish to connect the household appliance 105 to the known Wi-Fi network (exit branch N of the decision node 240), allowing the user to select a Wi-Fi network, for example as discussed above in connection with action nodes 245 and 250.

Just as an example of on-screen instructions supporting or guiding or assisting the Wi-Fi network selection in this use-case, the user device UD may open a dialog box asking or suggesting the use of (i.e., the connection to) a known Wi-Fi network, allow the user to confirm selection or deny selection of the SSID corresponding to the known Wi-Fi network, display the received SSID list in case of denial, and, upon SSID selection, open a fillable box for entering the password.

According to an embodiment, the method 200 comprises, at the user device UD, if a known Wi-Fi network exists among the available Wi-Fi networks (exit branch Y of the decision node 235), and if the user wishes to connect the household appliance 105 to the known Wi-Fi network (exit branch Y of the decision node 240), automatically retrieving (and/or entering) the network configuration data associated therewith, for example the corresponding password (action node 255).

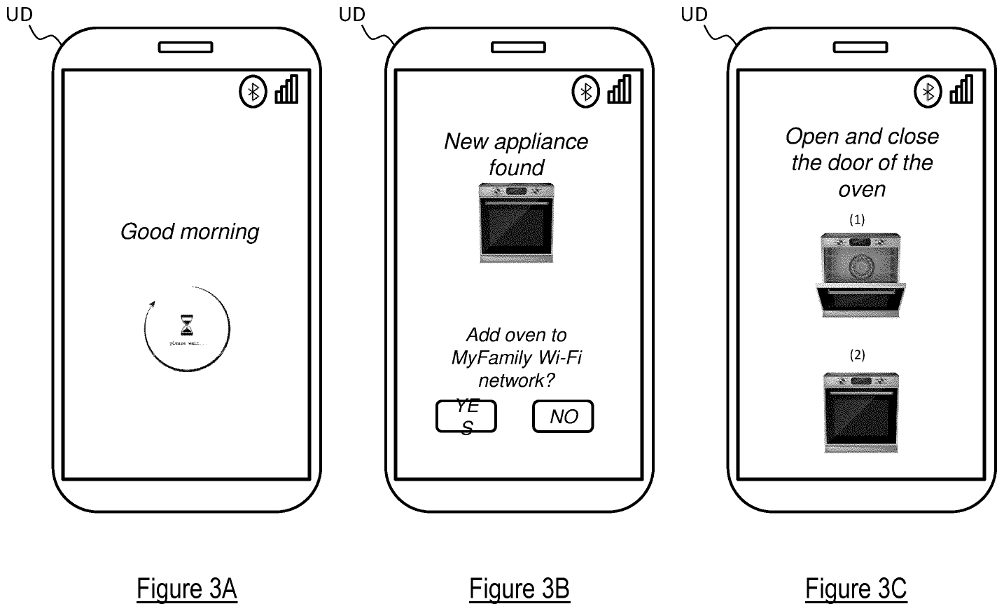

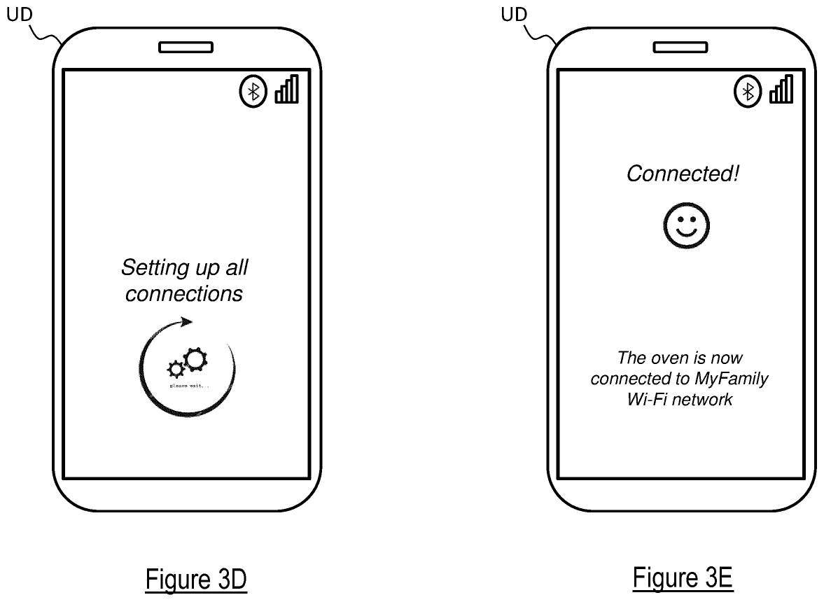

Just as an example of on-screen instructions supporting or guiding or assisting the Wi-Fi network selection in this use-case, the user device UD may open a dialog box asking or suggesting the use of (i.e., the connection to) a known Wi-Fi network, allow the user to confirm or accept selection or deny selection of the known Wi-Fi network, and, upon selection of the known Wi-Fi network, display a message associated with the next phase of connecting the household appliance to the wireless communication network. Exemplary screens that may be displayed on the user device UD in this use-case are illustrated in FIGS. 3A-3E (discussed in the following).

Without losing generality, the password may be locally stored in the user device UD, for example together with data associated with the software application, or remotely stored in and retrieved from the server 135 (or other entity external to, and connectable with, the user device UD).

According to an embodiment, not shown, in case that two or more known Wi-Fi networks exist among the available Wi-Fi networks, nodes 240-255 may be reiterated for each known Wi-Fi network, for example until one of the known Wi-Fi networks is selected or until all the known Wi-Fi networks have been evaluated (i.e., proposed by the user device UD) without that no one of them is selected. According to an embodiment, in case that two or more known Wi-Fi networks exist among the available Wi-Fi networks, nodes 240-255 may be reiterated for each known Wi-Fi network at a time: without losing generality, the known Wi-Fi networks may be evaluated (i.e., proposed by the user device UD) in an ordered manner, for example based on a predefined priority mechanism or on any other proper criterion (such as current signal level associated with each known Wi-Fi network).

According to an embodiment, the method 200 comprises, at the user device UD, prompting the user to perform a confirmation action, associated with the identified household appliance 105, to confirm an attendance or presence of the user in proximity of the household appliance 105 (action node 260)

According to an embodiment, said prompting is performed after inputting or retrieving the password (i.e., after manual or automatic password input, as the case may be).

According to an embodiment, the confirmation action, associated with the household appliance 105, comprises a direct interaction between the user and the household appliance 105. By direct interaction between the user and the household appliance 105, it is herein meant that the action is performed by the user without intermediation or mediation of any apparatus external to the user device UD and the household appliance 105.

According to an embodiment, the confirmation action, associated with the household appliance 105, comprises an action to be performed by the user on the household appliance 105.

According to an embodiment, the confirmation action, associated with the household appliance 105, comprises an action to be performed by the user on an actuatable mechanical part of the household appliance 105. By actuatable mechanical part of the household appliance 105 it is herein meant a component or part of the household appliance 105 that can be put into mechanical action or motion (such as a door, a button, a drawer, a rotary knob, a plug, a filter).

According to an embodiment, the confirmation action comprises moving a door of the household appliance 105. Just as an example, the confirmation action may comprise opening and/or closing the door.

According to an embodiment, the confirmation action comprises pressing and/or releasing a physical button on the household appliance 105, such as a home button or mode button (such as a button allowing the user to access menus and/or settings of the household appliance 105). In an example, when the confirmation action involves pressing and/or releasing a button, the confirmation action may be the pressing and/or releasing of a button that does not trigger, or is unlikely to trigger, another operation of the household appliance 105. For example, the confirmation action could be pressing and releasing the “home” button on a robotic vacuum cleaner, which would not trigger an operation or action by the household appliance 105 when the robotic vacuum cleaner is already in its “home” position. In another example, the button could be an existing button on a fridge such as a temperature control button or a freeze button. According to an embodiment, the confirmation action comprises pressing a combination of physical buttons on the household appliance 105. According to an embodiment, the confirmation action comprises pressing and holding the physical button (or a combination of physical buttons) for a predefined time (such as of the order of 2 to 5 seconds), i.e., a prolonged pressure of the physical button (or of the combination of physical buttons).

According to an embodiment, the confirmation action, associated with the household appliance 105, comprises an action to be performed by the user (e.g., a movement of the user) with respect the household appliance 105. Just as an example, the confirmation may comprise, by the user, positioning himself/herself (or a body part thereof, such as a head or a hand) with respect to (or at a proper point of) the household appliance 105, e.g., so as to enable the household appliance 105 to detect (through proper detection means of the household appliance 105) the presence of the user based on a recognition feature (such as biometric recognition) and/or a distance measurement.

According to an embodiment, the confirmation action, associated with the household appliance 105, comprises an action to be performed by the user on one or more virtual (i.e., not mechanically actuatable) parts of the household appliance 105 (such as virtual keys of a touchscreen display forming a control panel of the household appliance 105). According to an embodiment, the confirmation action comprises pressing a combination of virtual keys on the household appliance 105. According to an embodiment, the confirmation action comprises pressing and holding the virtual key (or a combination of virtual keys) for a predefined time (such as of the order of 2 to 5 seconds), i.e., a prolonged pressure of the virtual key (or the combination of virtual keys).

According to an embodiment, the confirmation action may have a level of complexity depending on whether it is desired that some categories of persons are excluded from performing the connection of the household appliance to the Wi-Fi network (so as to avoid troubles by reckless or unaware use of advanced features of the household appliance, such as the Wi-Fi connectivity).

Just as an example, a high or relatively high level of complexity of the confirmation action may discourage persons who are unfamiliar with technology to engage in the connection of the household appliance to the Wi-Fi network. Just as another example, a high or relatively high level of complexity of the confirmation action may prevent persons who should not freely use technology for safety rules/standards (such as the children and/or the kids) from understanding or fully understanding the confirmation action to be performed.

According to an embodiment, the prompting of the user to perform the confirmation action comprises textual and/or vocal and/or image indications or instructions. Just as an example, a static or animated image showing the door opening and/closing (or, more generally, the movement on the actuatable part to be actuated), with the addition of a short text may be displayed on a screen of the user device UD.

According to an embodiment, the prompting of the user to perform the confirmation action comprises prompting the user to perform the confirmation action within a prescribed time limit. Just as an example, together with the instructions about the confirmation action, a warning indication or memo may be provided to warn the user to perform the confirmation action within the prescribed time limit. The warning indication or memo may include a timer or a countdown. It may be provided with optical and/or acoustical indication for drawing the attention of the user. Just as an example, the optical indication may comprise a blinking light, and the acoustical indication may comprise emission of a beep sound. According to an embodiment, the optical and/or acoustical indication for drawing the attention of the user may change (e.g., increase, reduce, or vary an intermittency frequency) the closer the prescribed time limit gets. In another example, the user may not be informed of the time limit but the household appliance 105 and/or the user device UD may still set a timer corresponding to the prescribed time limit. A message displayed to the user on the screen of the user device UD may change as the timer approaches the prescribed time limit and may change again, or disappear altogether, when the timer has expired.

According to an embodiment, the confirmation action is based on the identification information. According to an embodiment, the confirmation action may be based on structural construction of the household appliance 105 (as indicated, for example, by type and model of the household appliance 105 contained in the identification information).

The structural construction of the household appliance 105 (and, hence, the parts of the household appliance 105 that are or may be involved in the confirmation action) may depend on the type of household appliance, and, for the same type of household appliance, it may depend on a specific model (for example, as indicated by model name, model number, and/or serial number of the household appliance 105 contained in the identification information): just as an example, for the household appliances provided with doors (such as washing machines or oven or refrigerators) door movement may be used as a confirmation action for those appliance models equipped with proper door movement sensing devices.

According to an embodiment, the prompting of the user to perform the confirmation action further comprises, at the user device UD, transmitting (through the SR communication channel) a corresponding notification to the household appliance 105 (action node 265_{B}). The transmission of the notification may also be omitted in basic embodiments.

According to an embodiment, the method 200 comprises, at the household appliance 105, upon reception of the notification (action node 265_{B}), enabling a detection of the confirmation action (action node 270). Without losing generality, the enabling of the detection of the confirmation action may comprise an instruction set, for example implemented by the control unit 110, to put the household appliance 105 in an operative condition (hereinafter, detection condition) capable of detecting the confirmation action. Just as an example, the enabling of the detection condition may activate one or more detection devices of the household appliance 105. Without losing generality, the detection device(s) may comprise one or more door movement detection devices (e.g., so as to detect the door opening and/or closing) and/or one or more drawer movement detection devices (e.g., so as to detect the drawer extraction and/or insertion).

According to an alternative embodiment, the detection of the confirmation action is enabled by default (for example, in that the respective detection device(s) is/are already involved in the normal operation of the household appliance). This could be the case of, for example, of confirmation actions performed on buttons, drawers, and rotary knobs (although this should not be construed limitatively).

According to an embodiment, the method 200 comprises, at the household appliance 105, detecting that the confirmation action is performed within a prescribed time limit (see decision nodes 275,280, discussed here below).

According to an embodiment, the prescribed time limit may be counted by the household appliance 105 by a proper timer thereof (such as a timer integrated as a functionality of the control unit 110). By setting a timer at the household appliance 105, in addition to, or instead of, a timer at the user device UD, security can be enhanced. By having a timer at the household appliance 105, risks associated with someone building a software application to fraudulently connect or control the household appliance 105, without checking that the confirmation action has performed, are reduced.

According to an embodiment, the prescribed time limit may be counted by the household appliance 105 starting from the reception of the notification at the household appliance 105 (action node 265A). According to an alternative embodiment, the prescribed time limit may be counted by the household appliance 105 starting from the enabling of the detection condition at the household appliance 105 (action node 270). In any case, the possibility that the prescribed time limit is counted by the household appliance 105 starting from the broadcasting of the identification information (action node 210_{A}), or from reception of the response to the broadcasting of the identification information (action node 220_{A}) is not excluded (for example, in that the notification of the prompting of the user to perform the confirmation action (action node 265_{B}) and the enabling of the detection condition (action node 270) are not provided). The prescribed time limit may be chosen to be relatively short to reduce the risk that an owner of the household appliance 105 carries out the confirmation action for another reason (i.e., not with the intention of connecting the household appliance 105 to a wireless communication network) in that prescribed time limit. The prescribed time limit may for example be between one and ten minutes. As a specific example, the prescribed time limit may be three minutes.

According to an embodiment, the household appliance 105 is in the detection condition as long as the prescribed time limit has not yet elapsed (exit branch N of the decision node 275), and the confirmation action has not yet been detected (exit branch N of the decision node 280).

According to an embodiment, the method 200 comprises, if no confirmation action is detected to be performed within the prescribed time limit (exit branch Y of decision node 275), returning back to action node 260 (wherein the user device UD, e.g., upon being properly informed of the elapsed prescribed time limit, prompts again the user to perform the confirmation action, and transmits the corresponding notification (when provided) to the household appliance 105). According to an alternative embodiment, not shown, the method 200 may comprise deactivation of the SR functionality at the household appliance 105 (and, hence, an end of the network provisioning procedure) if no confirmation action is detected to be performed within the prescribed time limit.

According to an embodiment, the method 200 comprises, if the confirmation action is detected to be performed within the prescribed time limit (exit branch N of the decision node 275 and exit branch Y of the decision node 280), transmitting (by the household appliance 105), through the SR communication channel, a corresponding notification (i.e., a notification about the successful detection of the confirmation action) to the user device UD (action node 285_{A}).

According to an embodiment, the method 200 comprises, at the user device UD, in response to being notified of the detected confirmation action (action node 285_{B}), transmitting to the household appliance 105, over the SR communication channel, the network configuration data for connection to the (selected) Wi-Fi network (action node 290_{B}).

The network configuration data transmitted by the household appliance 105 may be in encrypted form. A corresponding decryption key (for allowing the household appliance 105 to decrypt the network configuration data) may be transmitted (over the SR communication channel) by the user device UD (for security reasons, the decryption key being for example transmitted separately from the network configuration data).

According to an embodiment, the method 200 comprises, at the household appliance 105, upon reception of the network configuration data (action node 290_{A}), configuring the connection of the household appliance 105 to the Wi-Fi network according to the network configuration data (action node 295). The household appliance 105 can then, for example, connect to the server 135 via the Wi-Fi network and the Internet. The household appliance 105 may store an Internet Protocol address of the server in the memory module 125 (for example, in the mass-memory thereof) to allow it to automatically connect to the server 115 once connected to the Wi-Fi network.

Then, the method 200 ends (e.g., upon deactivation of the SR functionality at the household appliance 105).

With reference now to FIGS. 3A-3E, they show exemplary screens displayed on the user device UD during the network provisioning procedure, particularly in the use-case in which a known Wi-Fi network exists among the available Wi-Fi networks, and the user wishes to connect the household appliance to it.

Starting from FIG. 3A, a welcome screen may be displayed while reception of the identification information and scanning for available Wi-Fi networks is in progress.

Then, upon identification of the household appliance (for example, an oven) and upon identification of a known Wi-Fi network (for example, the Wi-Fi network named “MyFamily”), the user device UD may inform the user that a new household appliance has been found (for example, as illustrated, together with an image or picture thereof), and ask whether the user wishes the household appliance to be connected to the known Wi-Fi network (FIG. 3B). As illustrated, two virtual buttons (e.g., “YES” and “NO”) may also be displayed to allow the user to accept or deny connection of the household appliance to the known Wi-Fi network.

Upon acceptance, the user device UD may display instructions about the confirmation action to be performed by the user (FIG. 3C). The instructions may comprise textual instructions, instructions by means of drawings, or, as exemplary represented in the figure, both of them.

Upon detection of the confirmation action, automatic transmission of the corresponding network configuration data from the user device UD, and subsequent configuration of the household appliance based on the network configuration data take place. Meanwhile (FIG. 3D), the user device UD may display a corresponding network set up (or configuration) report screen (for example, together with a network set up progress status).

Upon network set up completion, the user device UD may display a message indicative of a successful connection of the household appliance to the known Wi-Fi network (FIG. 3E).

Therefore, in cases of a known Wi-Fi network, the network provisioning procedure only requires two inputs by the user (i.e., the acceptance to connect the household appliance to the known Wi-Fi network, and the confirmation action to be performed on the household appliance). As such, the method for connecting the household appliance to a wireless communication network described herein requires a very small number of user inputs while still providing a secure process.

It will be appreciated that the exemplary screens of FIGS. 3A to 3E correspond to just one non-limiting example of screens, and other screens and information are contemplated. For example, in some implementations, when the user has not opened the software application, the reception of the identification information may trigger a notification on the user device UD and the welcome screen of FIG. 3A may not be shown.

Although it has been described above that the apparatus to be connected to a wireless communication network is a household appliance, it could be any type of device. It may be a device in the household but the methods can also be applied to devices outside the household. Although it has been described that the method for connecting the device to the wireless communication network is carried out using short-range wireless communication technology, the method for connecting the device could also be done over other wireless communication technologies such as medium-range or long-range wireless communication technologies. The information required can be exchanged based on any suitable wireless communication protocol. The wireless communication protocol could be the same or different to the protocol of the wireless communication network. For example, the protocol could be a Wi-Fi protocol or a BLE protocol. The communication link established between the device to be connected and the user device would be separate to the wireless communication network.

While the prompting of the user to carry out the confirmation action could take place in response to, or at least following, reception of the identification information from the device to be connected as has been described herein, the user can, alternatively, be prompted to carry out a confirmation action before receiving the identification information. For example, the confirmation action could be an action to turn on the wireless communication functionality, such as the BLE functionality, over which the network configuration data will be sent in the device to be connected. In those cases, the user may be prompted via the software application to press a button or select a menu option at the device to be connected in order to turn on the wireless communication functionality to be used for sending the network configuration data. For example, a user may choose an option, using the software application, to provision a new device and as part of the provisioning process the software application may cause the user device to display a message on the screen of the user device to turn on Bluetooth™, or other suitable wireless communication technology. Once turned on, the wireless communication unit would start broadcasting identification information which the corresponding wireless communication unit on the user device can receive. The broadcast of identification information, using the wireless communication technology, would then indicate to the user device that the confirmation action has been performed and that, therefore, the user is in proximity of the device to be connected and the user device can then transmit the network configuration data to the device to be connected. In another example, the confirmation action could be to configure the device to be connected to be discoverable. The fact that the user device can discover and receive information from the device to be connected then indicates to the user device that the confirmation action has been performed. In some implementations the device to be connected can also send a dedicated notification to the user device that the confirmation action has been performed. It will be appreciated that, also when the user is prompted to carry out the confirmation action before the device to be connected starts broadcasting, many of the processes described above, such as, but not limited to, the pairing (or otherwise establishing trusted communication), identification of the device to be connected, providing a list of available wireless communication networks and selecting an appropriate wireless communication network from the list, retrieving or receiving the corresponding password, notifying the device to be connected that a user is about to perform the confirmation action, setting of a timer in the user device and/or the device to be connected and using the network configuration data to connect to the wireless communication network may be realised as appropriate as part of the process.

Naturally, in order to satisfy local and specific requirements, a person skilled in the art may apply to the above disclosure many logical and/or physical modifications and alterations. More specifically, although the disclosure has been provided with a certain degree of particularity with reference to embodiments thereof, it should be understood that various omissions, substitutions and changes in the form and details as well as other embodiments are possible. In particular, different embodiments of the disclosure may even be practiced without the specific details (such as the numeric examples) set forth in the preceding description for providing a more thorough understanding thereof; on the contrary, well-known features may have been omitted or simplified in order not to obscure the description with unnecessary particulars.

For example, the present disclosure lends itself to be implemented through an equivalent method (by using similar steps, removing some steps being not essential, or adding further optional steps); moreover, the steps may be performed in different order, concurrently or in an interleaved way (at least partly).

Moreover, the household appliance (or, more generally, the device or household device) and/or the system may have a different structure or include equivalent components. Moreover, any component of the household appliance (or, more generally, the device or household device) and/or the system may be separated into several elements, or two or more components may be combined into a single element; furthermore, each component can be replicated to support the execution of the corresponding operations in parallel. It should also be noted that (unless otherwise indicated) any interaction between different components generally does not need to be continuous and may be either direct or indirect through one or more intermediaries.

1. A method for connecting a household device to a wireless communication network, the method comprising:
at the household device, broadcasting, using wireless communication technology, identification information of the household device;
at a user device associated with a user of the household device:
receiving the identification information of the household device using the wireless communication technology;
identifying the household device based on the received identification information, and
prompting the user to perform a confirmation action, associated with the identified household device, to confirm an attendance of the user in proximity of the household device;
at the household device, detecting the confirmation action and notifying it to the user device using the wireless communication technology;
at the user device, in response to being notified of the detected confirmation action, transmitting to the household device, using the wireless communication technology, network configuration data for connection to the wireless communication network;
at the household device, configuring a connection of the household device to the wireless communication network according to the network configuration data.

2. The method according to claim 1, wherein the confirmation action, associated with the household device, comprises a direct interaction between the user and the household device.

3. The method according to claim 1, wherein the confirmation action comprises an action to be performed on an actuatable mechanical part of the household device.

4. The method according to claim 1, wherein the confirmation action, associated with the household device, comprises moving a door of the household device.

5. The method according to claim 1, wherein the confirmation action, associated with the household device, comprises pressing and/or releasing a button on the household device.

6. The method according to claim 1, wherein the confirmation action, associated with the household device, is based on the identification information.

7. The method according to claim 1, wherein the identification information comprises at least one between a type of household device and a model of the household device.

8. The method according to claim 1, wherein said detecting the confirmation action further comprises, at the household device, detecting that the confirmation action is performed within a prescribed time limit.

9. The method according to claim 1, further comprising, if no confirmation action is detected to be performed within a prescribed time limit, repeating said prompting the user to perform the confirmation action.

10. The method according to claim 8, wherein said prompting the user to perform the confirmation action further comprises, at the user device, transmitting a corresponding notification to the household device, the prescribed time limit being counted by the household device starting from reception of the notification at the household device.

11. The method according to claim 1, further comprising, following reception at the user device of the identification information, transmitting, at the user device, a response to the household device to allow pairing of the household device and the user device to each other, wherein the prompting of the user to perform the confirmation action is performed following pairing of the household device and the user device.

12. The method according to claim 1, further comprising, at the household device, providing, to the user device a set of available wireless communication networks, and, at the user device, selecting a wireless communication network among the set of available communication networks, said prompting the user to perform the confirmation action being performed in response to said selecting a wireless communication network.

13. The method according to claim 12, wherein said selecting a wireless communication network comprises, if a known wireless communication network exists among the available wireless communication networks, automatically retrieving the network configuration data associated with the known wireless communication network, following user input indicating that the user wishes to connect the household device to the known wireless communication network.

14. The method according to claim 1, further comprising, at the household device, performing wireless communication activation at a power on of the household device.

15. The method according to claim 1, further comprising, at the household device, performing wireless communication deactivation after a predefined time.

16. The method according to claim 1, wherein the wireless communication technology is based on at least one among selected from the group consisting of: Bluetooth, NFC, RFID, ZigBee, and UWB technologies.

17. The method according to claim 1, wherein the user device is at least one selected from the group consisting of a smartphone, a tablet, and a wearable device.

18. A method implemented by a household device for connecting the household device to a wireless communication network, the method comprising:
broadcasting, using a wireless communication technology, identification information of household device to allow the household device to be identified by a user device, the user device being associated with a user of the household device;
detecting a confirmation action, associated with the household device, performed by the user to confirm an attendance of the user in proximity of the household device;
notifying, using the wireless communication technology, the detection of the confirmation action to the user device;
receiving from the user device, using the wireless communication technology, network configuration data for the wireless communication network, and
configuring a connection of the household device to the wireless communication network according to the network configuration data.

19. A method implemented by a user device for connecting a household device to a wireless communication network, the method comprising:
receiving identification information of the household device broadcasted by the household device using a wireless communication technology;
identifying the household device according to the identification information;
prompting a user to perform a confirmation action, associated with the identified household device, to confirm an attendance of the user in proximity of the household device;
receiving, using the wireless communication technology, a notification of detection of the confirmation action from the household device, and
transmitting, using the wireless communication technology after receiving the notification of the detection of the confirmation action from the household device, network configuration data for connecting the household device to the wireless communication network.

20. A computer program product directly loadable into an internal memory storage of a processing unit within a household device, the computer program product comprising software for causing the household device to perform the steps of the method according to claim 1 when the computer program product is run on the household device.

21. A computer program product directly loadable into an internal memory storage of a processing unit within a user device, the computer program product comprising software for causing the user device to perform the steps of the method according to claim 19 when the computer program product is run on the user device.

22. A household device comprising:
a control unit for controlling an operation of the household device; at least one wireless communication apparatus for allowing the household device to connect to a wireless communication network and for allowing the household device to communicate with a user device, associated with a user of the household device, using a communication link separate to the wireless communication network, and
wherein the control unit is configured to:
broadcast, through the at least one wireless communication apparatus, identification information of the household device to allow the household device to be identified by the user device;
detect a confirmation action, associated with the household device, performed by the user to confirm an attendance of the user in proximity of the household device, after the communication link between the household device and the user device has been established;
notify, through the at least one wireless communication apparatus and the communication link, the detection of the confirmation action to the user device;
receive from the user device, through the communication link and the at least one wireless communication apparatus, network configuration data associated with the wireless communication network, and
configure the at least one wireless communication apparatus with the network configuration data.

23. A method for connecting a first device to a wireless communication network after a communication link between the first device and a second device has been established, the method comprising:
at the second device, causing a prompt to be displayed, on a user interface of the second device, to a user of the second device to perform a confirmation action, associated with the first device, to confirm an attendance of the user in proximity of the first device;
at the first device, communicating information indicative of the confirmation action having been performed, to the second device using the communication link;
at the second device, in response to receiving the information indicative of the confirmation action having been performed, transmitting to the first device, using the communication link, network configuration data for connection to the wireless communication network; and
at the first device, configuring a connection of the first device to the wireless communication network according to the network configuration data.
